(19) United States
(12) Patent Application Publication
(10) Pub. No.: US 2007/0067681 A1
(43) Pub. Date: Mar. 22, 2007

(54) Maintenance system for image processing device, image processing device, maintenance information display method for image processing device, storage medium, and computer data signal

(76) Inventors: Yuji Hikawa, Ebina-shi (JP); Hiroshi Yagi, Ebina-shi (JP); Yukio Tajima, Ebina-shi (JP); Satoshi Kamiya, Ebina-shi (JP); Kazuko Kirihara, Ebina-shi (JP); Takahiko Suzuki, Kawasaki-shi (JP); Makoto Takada, Ebina-shi (JP); Tomokazu Yoshimura, Ebina-shi (JP)

Correspondence Address: Gauthier & Connors LLP, Suite 2300, 225 Franklin Street, Boston, MA, 02110, US

(21) Appl. No.: 11/523,346

(22) Filed: Sep. 19, 2006

(30) Foreign Application Priority Data
Sep. 21, 2005 (JP) 2005-273164
Sep. 8, 2006 (JP) 2006-243780

(51) Int. Cl. G06F 11/00

(52) U.S. Cl. 714/47

(57) ABSTRACT

There is provided a maintenance system including a maintenance server that provides maintenance information and an image processing device that has at least one of copy, print, facsimile and scan functions and which, upon detection of a maintenance event upon which a maintenance process to be carried out with respect to the image processing device, accesses the maintenance server, acquires from the maintenance server maintenance information indicating a maintenance process corresponding to the detected maintenance event, and displays the acquired maintenance information on a display.

### BACKGROUND

1. Technical Field

The present invention relates to a maintenance system for an image processing device having at least one of the copy, print, facsimile, and scan functions.

2. Related Art

There is available an image processing device which has at least one of the copy, print, facsimile, and scan functions. Conventionally, maintenance of the above-described image processing device, such as coping with a failure, preparation or exchange of consumables, regular checkup, and so forth, is carried out by a customer engineer (CE) or a user while referring to an operation manual or the like.

### SUMMARY

According to one aspect of the invention, there is provided a maintenance system, comprising:

a maintenance server that provides maintenance information; and

an image processing device that has at least one of copy, print, facsimile and scan functions and which, upon detection of a maintenance event upon which a maintenance process to be carried out with respect to the image processing device, accesses the maintenance server, acquires from the maintenance server maintenance information for indicating a maintenance process corresponding to the detected maintenance event, and displays the acquired maintenance information on a display.

### BRIEF DESCRIPTION OF THE DRAWINGS

Exemplary embodiments of the present invention will be described in detail by reference to the following figures, wherein:

FIG. 1 is a block diagram showing a schematic structure of a maintenance system according to an exemplary embodiment;

FIG. 2 is a block diagram showing a structure of an MFP and a maintenance server;

FIG. 3 is a flowchart of an operational procedure to be followed by a maintenance system upon occurrence of a failure;

FIG. 4 is a flowchart of an operational procedure to be followed by the maintenance system when consumables are consumed;

FIG. 5 is a flowchart showing an operational procedure to be followed by the maintenance system when an operation mode is shifted to a maintenance mode; and

FIG. 6 is a diagram showing an exemplary hardware structure of a computer.

### DETAILED DESCRIPTION

In the following, an exemplary embodiment of the present invention will be described with reference to the accompanying drawings.

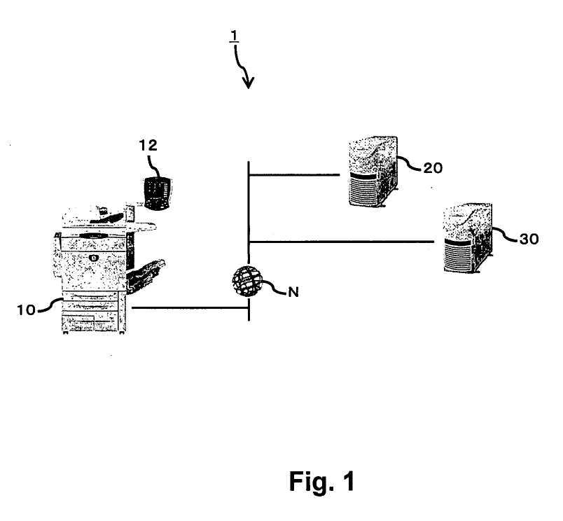

FIG. 1 is a block diagram showing a schematic structure of a maintenance system 1 according to this exemplary embodiment. This maintenance system 1 is constructed from an image processing device 10 which has at least one of the copy, print, facsimile, and scan functions, and a maintenance server 20 connected to the image processing device 10 via a network N, such as the Internet, an intranet, and so forth. Here, the image processing device 10 is a multi-function peripheral (MFP) having two or more functions among the above-described functions, for example, and is hereinafter referred to as an MFP 10. It should be noted that although in FIG. 1 a single image processing device 10 is connected to the maintenance server 20, multiple image processing devices 10 may be connected to the maintenance service 20.

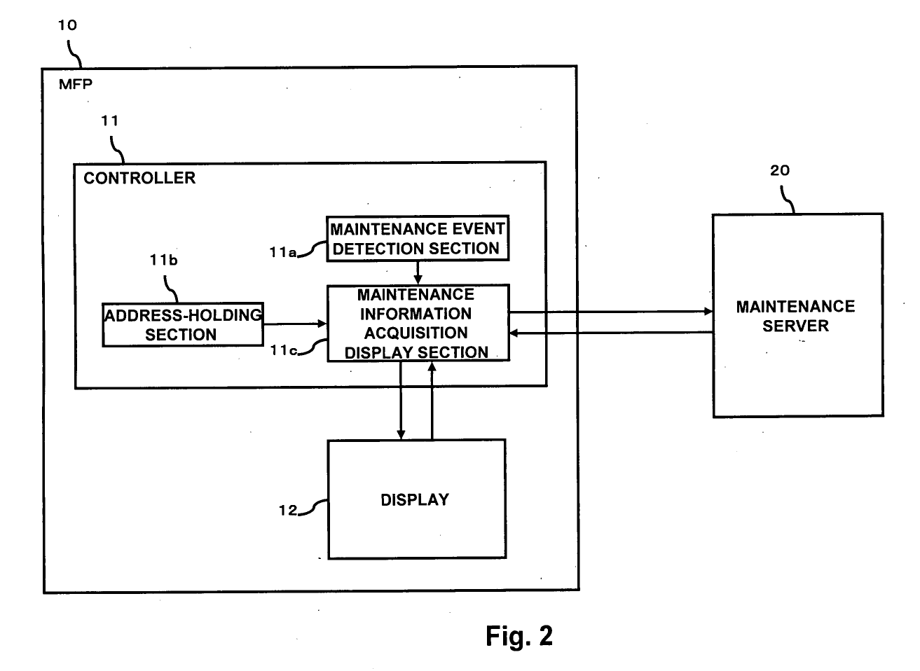

FIG. 2 is a block diagram showing a structure of the MFP 10 and the maintenance server 20. In the following, a structure of the MFP 10 and the maintenance server 20 will be described in detail with reference to FIG. 2.

In FIG. 2, the MFP 10 has a controller 11 and a display 12.

The controller 11 has, as function blocks thereof, a maintenance event detection section 11a, an address holding section 11b, and a maintenance information acquisition display section 11c. In this exemplary embodiment, the controller 11 is constructed from a CPU (Central Processing Unit), ROM (Read Only Memory), RAM (Random Access Memory), NVRAM (Nonvolatile RAM), and so forth. The functions of the controller 11 are realized by the CPU executing a program stored in a recording medium such as a ROM.

The maintenance event detection section 11a detects a maintenance event upon which maintenance is required to be carried out with respect to the MFP 10. In this exemplary embodiment, the maintenance event detection section 11a detects as a maintenance event, for example, a failure occurring in the MFP 10, consumption of consumables (for example, a consumable component and consumable supplies), shift to a maintenance mode, or the like. A maintenance mode refers to an operation mode in which a customer engineer (CE) carries out an operation for maintenance or checkup of the MFP 10, including diagnosis, adjustment, repair, or the like, of the MFP 10.

Specifically, for the respective failure items, the maintenance event detection section 11a determines, from a predetermined failure determination condition, for example, whether or not any such failure has occurred. When it is determined that a failure has occurred, a failure code corresponding to that failure is determined.

For example, a determination is made as to whether or the output value of a temperature sensor of a fixing device or fuser has remained lower than a predetermined value for greater than a predetermined period of time. When such a situation has been determined to exist, a failure code corresponding to that failure (an abnormal output from a fuser temperature sensor) is determined.

Likewise, for the respective consumables, the maintenance event detection section 11a determines, for example, whether or not the amount of consumed consumables is equal to or greater than a predetermined amount. Alternatively, whether or not the amount of remaining consumables is equal to or smaller than a predetermined amount may be determined. When it is determined that the amount of consumed consumables is equal to or greater than the predetermined amount or the amount of remaining consumables is equal to or smaller than the predetermined amount, a consumables code corresponding to the consumables is determined.

For example, when it is determined that a photosensitive material has been scraped in an amount equal to or greater than a predetermined amount, a consumable code corresponding to the photosensitive member is determined. Alternatively, when it is determined that only the amount of toner equal to or smaller than a predetermined amount remains, a consumable code corresponding to the toner is determined.

Further, the maintenance event detection section 11a determines, for example, whether or not an input operation to shift to the maintenance mode has been performed. When it is determined that such an input operation has been performed, the maintenance event detection section 11a determines that the operation mode is shifted to the maintenance mode. It should be noted that an operation to shift to the maintenance mode may be, for example, an operation to input a predetermined pattern via the keys of a control panel (not shown) of the MFP 10.

The address holding section 11b holds an address of a maintenance server 20 on a network, to be accessed upon detection of a maintenance event. Specifically, the address holding section 11b stores, for example, the URL (Uniform Resource Locator) of the maintenance server 20 registered therein. The address held in the address holding section 11b is adapted to be changed via an external information processing device connected to the MFP 10 or the user interface (UI) of the MFP 10 in order to accommodate change of the address of the maintenance server 20 to be accessed.

Upon detection of a maintenance event by the maintenance event detection section 11a, the maintenance information acquisition display section 11c accesses the maintenance server 20 which is designated by the address held in the address holding section 11b, acquires therefrom maintenance information indicating a maintenance process corresponding to the detected maintenance event, and displays the acquired maintenance information on a display.

Specifically, when the maintenance event detection section 11a detects a failure, the maintenance information acquisition display section 11c acquires from the maintenance server 20 information indicating a process to be carried out to cope with the failure and displays the information on the display 12.

Alternatively, when the maintenance event detection section 11a detects consumption of the consumables, the maintenance information acquisition display section 11c acquires from the maintenance server 20 information indicating a process to be carried out to prepare or exchange the consumables, and displays the information on the display 12.

Further alternatively, when the maintenance event detection section 11a detects shift to the maintenance mode, the maintenance information acquisition display section 11c acquires from the maintenance server 20 information indicating a maintenance process to be carried out in the maintenance mode and displays the information on the display 12.

In this exemplary embodiment, the maintenance information acquisition display section 11c has a web browser function, and, upon detection of a maintenance event, obtains or creates a URL which contains the address of the maintenance server 20 and a character array corresponding to the detected maintenance event. Then, the maintenance information acquisition display section 11c accesses the maintenance server 20 on the basis of the URL, acquires therefrom a web page corresponding to the URL, and displays the same. It should be noted that a character array corresponding to a maintenance event may include a character array indicative of a failure code, a character array indicative of a consumables code, a character array indicative of shift to a maintenance mode, and so forth.

In one example, the host name of the maintenance server 20 may be held in the address holding section 11b, and the maintenance information acquisition display section 11c may create a URL by adding to the host name of the maintenance server 20 held in the address holding section 11b the path name of a predetermined CGI (Common Gateway Interface) program and a query value indicative of the detected maintenance event (a failure code, a consumables code, shift to a maintenance mode).

In another example, the address holding section 11b may hold a URL (for example, a combination of the host name of the maintenance server 20 and the path name corresponding to each of the maintenance events) corresponding to each of the respective maintenance events, and the maintenance information acquisition display section 11c may obtain the URL corresponding to the detected maintenance event from the address holding section 11b.

The display 12, which here is a touch panel liquid crystal display, displays the information acquired from the maintenance server 20. This display 12 may be a relatively large type, as shown in FIG. 1, and may display any information other than the information described above.

The maintenance server 20 is a server to provide the MFP 10 with maintenance information indicating a maintenance process to be carried out with respect to the MFP 10. The maintenance server 20 is formed from a computer including a CPU, ROM, RAM, a hard disk device, and so forth. Alternatively, the maintenance server 20 may be formed from multiple computers. For example, the maintenance server 20 may be formed from multiple server computers provided for every MFP machine type, every region, or every maintenance event.

The maintenance server 20 may provide the MFP 10 with the maintenance information in the form of single-page information. In particular, when the maintenance process includes multiple steps, the maintenance information may be preferably provided in a dialogue form.

As described above, the maintenance information provided by the maintenance server 20 may include information indicating a process to be carried out to cope with a failure, information indicating a process to be carried out to prepare or exchange consumables, information indicating a maintenance process to be carried out in a maintenance mode, and so forth.

Information indicating a process to be carried out to cope with a failure may include a screen image prompting turning on/off of a power supply or checking of a connecter connection, a screen image showing contact information of a maintenance center, and so forth. Information indicating a process to be carried out to prepare or exchange consumables may include information for indicating on-line ordering of consumables (a web page for on-line order of consumables, or the like), an on-line order form for consumables, information for prompting preparation of consumables having a specific commodity code, contact information for the seller of consumables, information indicating a procedure to exchange consumables, and so forth. Information indicating a maintenance process to be carried out in the maintenance mode may include information indicating a diagnosis procedure, an adjustment procedure, a failure recovery procedure, upgrading of a firmware version, and so forth.

The above-described maintenance information is registered and stored in advance in the maintenance server 20 and desirably updated. For example, when a new method for coping with a certain failure is found, the information indicating a process to be carried out to cope with the failure is updated. Likewise, when a change arises in the specifications or seller of certain consumables, information indicating a process to be carried out to prepare or exchange the consumables is updated. Further, when the firmware version is upgraded, information indicating a maintenance process to be carried out in the maintenance mode is updated.

In providing the MFP 10 with maintenance information, the maintenance server 20 may cause the MFP 10 to download and execute a test program, if necessary. Alternatively, the MFP 10 may be caused to download and print a test pattern. Thereafter, the maintenance server 20 may obtain the result of execution of the test program from the MFP 10, perform diagnosis on the basis of the result, and cause the MFP 10 to display the result of the diagnosis or to change the setting of a relevant parameter on the basis of the diagnosis result.

Alternatively, the maintenance server 20 may cause the MFP 10 to scan the printed matter where the test pattern is printed, obtain the acquired image data from the MFP 10, make a diagnosis on the basis of the image data, and cause the MFP 10 to display the result of the diagnosis or to change the setting of a relevant parameter on the basis of the diagnosis result. Further alternatively, the maintenance server 20 may cause the MFP 20 to download firmware to upgrade the firmware version.

In this exemplary embodiment, the maintenance server 20 has a web server function, for example, and, in response to an access by the MFP 10 on the basis of the URL, sends a web page corresponding to that URL to the MFP 10 having made the access.

In one example, the maintenance server 20 may have a web server and a CGI program. When the maintenance server 20 is accessed on the basis of the URL which contains the path name of a predetermined CGI program and a query value indicative of a maintenance event, the web server activates the CGI program specified by the path name. According to the CGI program, a web page corresponding to the query value; that is, a maintenance event, is created. The Web server sends the created web page to the MFP 10.

In another example, when the maintenance server 20 is accessed on the basis of the URL which contains the path name corresponding to a maintenance event, the web server obtains a web page specified by the path name and sends the same to the MFP 10.

In the following, an operation of the maintenance system 1 having the above-described structure will be described in connection with the respective cases where a failure occurs, consumables are consumed, and an operation mode is shifted to the maintenance mode.

(Failure Occurred)

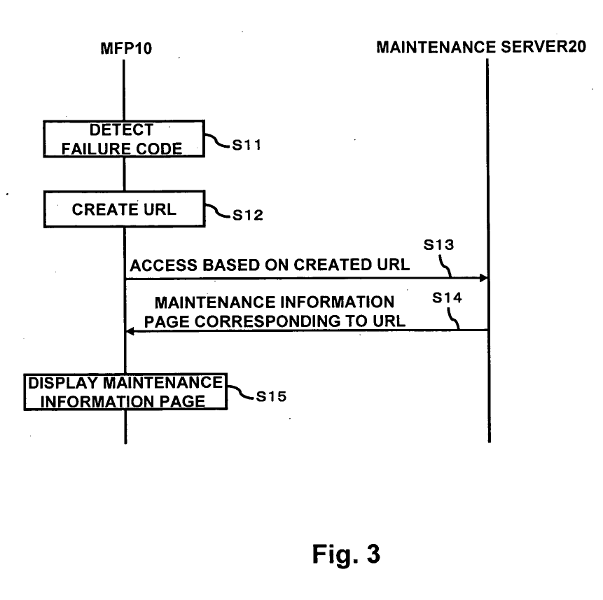

FIG. 3 is a flowchart showing a process to be carried out by the maintenance system 1 when a failure occurs in an MFP.

In FIG. 3, should any failure occur to the MFP 10, the maintenance event detection section 11a detects a failure code corresponding to that failure event and notifies the maintenance information acquisition display section 11c of the detected failure code (S11). In the following, an example will be described in which a communication error occurs in an optional device (an auto duplex unit, a paper feeding tray of large capacity, and so forth), and a failure code corresponding to that communication error; namely, “153,” is determined.

Having been notified of the failure code by the maintenance event detection section 11a, the maintenance information acquisition display section 11c creates a URL to acquire maintenance information corresponding to that failure code (S12). Specifically, the maintenance information acquisition display section 11c reads the host name of the maintenance server 20 and the path name of the CGI program from the address holding section 11b, and creates a URL; for example,

“http://www.xxx.fujixerox.co.jp/yyy/fault.cgi?code=153”, by adding the failure code “153” as a CGI parameter to the names read. Then, the maintenance information acquisition display section 11c accesses the maintenance server 20 on the basis of the created URL (S13).

Having been accessed by the MFP 10 on the basis of the URL, the maintenance server 20 sends a maintenance information page corresponding to that URL to the MFP 10 (S14). Specifically, in the maintenance server 20, the Web server activates the CGI program specified by the path name “yyy/fault.cgi.” According to the CGI program, a maintenance information page corresponding to the failure code “153” is created on the basis of the query value “code=153,” and forwarded to the web server. The web server sends the maintenance information page received from the CGI program to the web browser of the MFP 10.

In the MFP 10, the maintenance information acquisition display section 11c receives the maintenance information page from the maintenance server 20, and displays the received maintenance information page on the display 12 (S15).

After step S15, in an example, the maintenance server 20 proceeds with the maintenance information page displayed in the dialogue form on the display 12 of the MFP 10. Specifically, the maintenance server 20 receives via the maintenance information acquisition display section 11c an input performed by the user on the maintenance information page, and proceeds with the screen image shown on the display 12 of the MFP 10 in response to the input by the user.

The user proceeds with the process to cope with a failure, following the content of the maintenance information page shown on the display 12. Specifically, a screen image prompting checking of the connection of the connector of the option device is initially shown here, and in response thereto the user checks the connecter connection. When the connecter is not connected, the user connects the connecter and then touches the “connecter not connected” button on the screen, whereby the process is terminated.

Meanwhile, when the connecter is connected, the user touches the “connecter connected” button on the screen. Thereupon, contact information of a maintenance center appears on the display 12 together with a screen image prompting the user to contact the maintenance center. In response, the user contacts the maintenance center.

(Consumables Consumed)

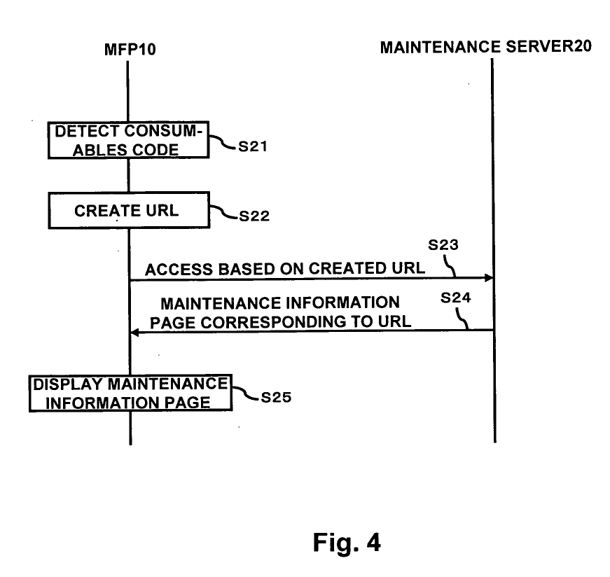

FIG. 4 is a flowchart showing a process to be carried out by the maintenance system 1 when consumables of the MFP are consumed.

In FIG. 4, when any consumables of the MFP 10 are consumed, the maintenance event detection section 11a detects a consumables code corresponding to the consumables consumed, and notifies the maintenance information acquisition display section 11c of the consumables code detected (S21). It is supposed here that the toner is consumed to an amount equal to or smaller than a predetermined amount. Then, a consumable code “503” corresponding to the toner is determined.

Having been notified of the consumables code by the maintenance event detection section 11a, the maintenance information acquisition display section 11c creates a URL to acquire maintenance information corresponding to the notified consumables code (S22). Here, it is assumed that the URL “http://www.xxx.fujixerox.co.jp/yyy/fault.cgi?code=503” is created when the above-described failure occurs.

Thereafter, the maintenance information acquisition display section 11c accesses the maintenance server 20 on the basis of the created URL (S23). In response to the access by the MFP 10 on the basis of the above-mentioned URL, upon occurrence of the failure the maintenance server 20 sends a maintenance information page corresponding to the consumables code “503” to the MFP 10 having made the access (S24). In the MFP 10, having received the maintenance information page from the maintenance server 20, the maintenance information acquisition display section 11c displays the received maintenance information page on the display 12 (S25). After step S25, for example, the maintenance server 20 proceeds with the maintenance information pages interactively.

The user proceeds with the process to prepare or exchange the consumables, following the content of the maintenance information page shown on the display 12. Specifically, as a page for ordering toner is initially shown, the user inputs all required items on the toner order page and touches the “order” button. Then, the maintenance information acquisition display section 11c sends the order information to the consumables order receiving server 30 on the network N, either directly or via the maintenance server 20. With the above, toner will be delivered to the user who placed the order.

(Shift to Maintenance Mode)

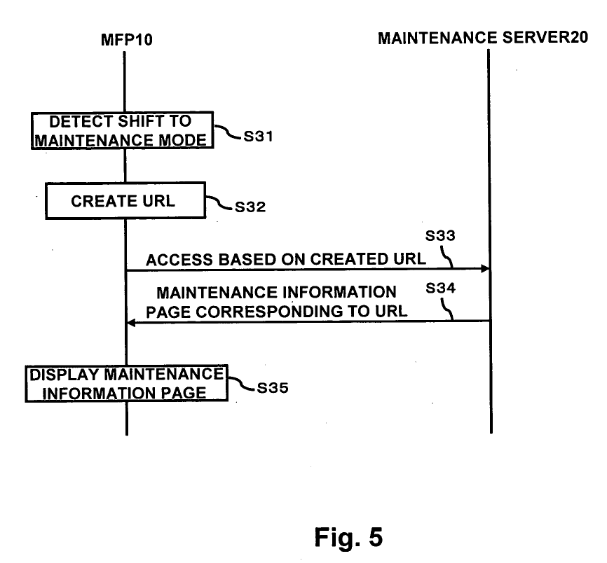

FIG. 5 is a flowchart showing a process to be carried out by the maintenance system 1 after the operation mode is shifted to the maintenance mode. In FIG. 5, when a CE carries out a UI operation to shift to the maintenance mode, the maintenance event detection section 11a detects that the operation mode is shifted to the maintenance mode, and notifies the maintenance information acquisition display section 11c of the shift (S31).

Having been notified of the shift to the maintenance mode by the maintenance event detection section 11a, the maintenance information acquisition display section 11c creates a URL to acquire maintenance information corresponding to the maintenance mode (S32). Here, it is assumed that the URL “http://www.xxx.fujixerox.co.jp/yyy/maintenance.html” is created.

Then, the maintenance information acquisition display section 11c accesses the maintenance server 20 on the basis of the created URL (S33). In response to the access by the MFP 10 on the basis of the URL, the maintenance server 20 sends the maintenance information page specified by the path name “yyy/maintenance.html” to the MFP 10 (S34). In the MFP 10, having received the maintenance information page from the maintenance server 20, the maintenance information acquisition display section 11c displays the maintenance information page on the display 12 (S35). After step S35, for example, the maintenance server 20 proceeds with the maintenance information pages through user interaction.

The CE carries out a maintenance process, such as a failure recovery process, an adjustment process, a regular checkup process, a special maintenance process, and so forth, following the content of the maintenance information page shown on the display 12. It should be noted that a regular checkup process may be a checkup process to be regularly carried out by a CE to ensure a required level of performance of the MFP 10, and a special maintenance process may be a process to be carried out simultaneously with respect to many MFPs 10 as a countermeasure against a significant quality problem, or the like. A special maintenance process is not a type of a process which is required all the time, but a type of process which is required only when a significant countermeasure is required to be taken.

In this exemplary embodiment, should any special maintenance process be required, a screen image prompting execution of a special maintenance process is initially shown after the operation mode is shifted to the maintenance mode. Then, the CE carries out the special maintenance process in accordance with the screen image.

For example, when the firmware version is updated, a screen image prompting upgrade of the firmware version is initially displayed. Then, the CE touches a “upgrade version” button on the screen, and in response thereto, the MFP 10 downloads firmware of the new version from the maintenance server 20 to upgrade the firmware version.

Meanwhile, when no special maintenance process is required, a screen image prompting selection of a process content is shown after the operation mode is shifted to the maintenance mode. Accordingly, the CE selects his/her desired process content interactively to thereby proceed with the maintenance process.

For example, the CE touches the “failure recovery” button on the menu screen, and, informs the maintenance server 20 of the content of the failure in accordance with the screen image inquiring about the content of the failure. Thereafter, the CE proceeds with the process to detect the cause of the failure in accordance with the screen image assisting detection of the cause corresponding to the content of the failure, and further with the process for recovery in accordance with the screen image assisting the recovery corresponding to the detected cause.

It should be noted that in the above-described structure, in one example, the maintenance information acquisition display section 11c sends a parameter concerning the MFP 10 to the maintenance server 20 when accessing the maintenance server 20, and the maintenance server 20 in turn sends the maintenance information corresponding to the received parameter back to the MFP 10. A parameter concerning the MFP 10 may include a model name, an region code which denotes an area in which use of the MFP are intended, a serial number, a firmware version, a meter value for monochrome printing, a meter value for color printing, a set value of an operation parameter, output values of a variety of sensors, and so forth. These parameters are sent to the maintenance server 20 as a query value of the URL, such as is described below.

“http://www.xxx.fujixerox.co.jp/yyy/fault.cgi?ser=041819003&rom=1.20.4&m1=4209&m2=2031&code=153.”

Here, “ser” refers to a serial number, “rom” refers to a firmware version, “m1” refers to a meter value for monochrome printing, “m2” refers to a meter value for color printing, and “code” refers to a failure or consumables code. The maintenance server 20 provides the MPF 10 with maintenance information which differs for every model name, region code, device, or state of use even with respect to identical maintenance events.

Also, in the above-described structure, the maintenance server 20 may collect information concerning a failure or consumables from multiple MFPs 10, gather statistics concerning the failure or the service lives of the consumables on the basis of the collected information, and display the information on the basis of the result of the statistics in the respective MFPs 10.

Specifically, the maintenance server 20 may receive a failure code, a consumables code, and a parameter concerning the MFP 10 (a machine type, a state of use, and so forth) from the multiple MFPs 10, and store the information in a database. Then, the maintenance server 20 may extract from the database statistics data concerning the failure or the service lives of the respective consumables. For example, the maintenance server 20 may extract statistics data for every model name, region code, state of use, and so forth, concerning each failure (an occurrence rate, the number of occurrence, and so forth) and concerning consumption of consumables (the average and a distribution graph of service lives), then displays these statistics data in the respective MFPs 10 as a part of or separately from the maintenance information to be provided upon detection of any maintenance event.

Also, in the above-described structure, the MFP 10 may be constructed such that the function for accessing the maintenance server 20 and displaying a screen image can be switched on/off.

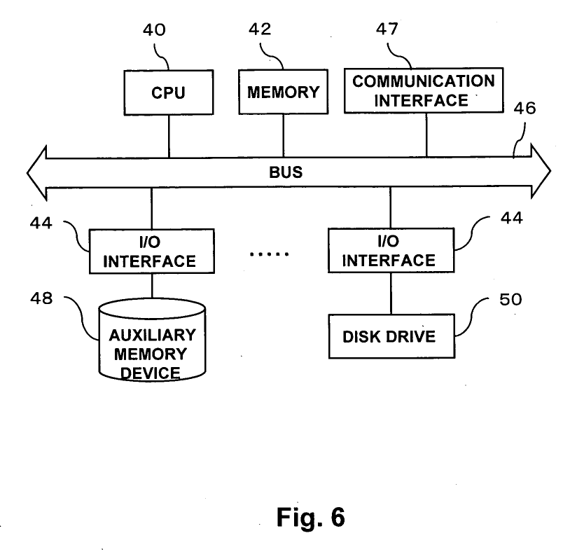

In the above described system, the maintenance server 20 is typically realized by a general purpose computer executing a program which describes the respective functions or the content of processes of the above-described maintenance server 20. The computer has a hardware structure in which, for example, a CPU (Central Processing Unit) 40, memory (primary storage) 42, various I/O (input/output) interfaces 44, a communication interface 47, and so forth are connected to one another via a bus 46, as shown in FIG. 6.

Also, to the bus 46, an auxiliary memory device 48, such as a hard disk, a flash memory, or the like, and a disk drive 50 for reading data from portable nonvolatile recording media of a variety of standards, such as a CD, a DVD, a flash memory card, and so forth, are connected via the I/O interfaces 44. In relation to the memory, the drive 48 or 50 functions as an external memory device.

A program which describes the content of the process according to the embodiment may be installed in the auxiliary memory device 48 from a memory medium such as a CD, DVD, or the like. Alternatively, such a program may be downloaded from a device in a network such as a LAN, or the like, via the communication interface 37, and installed in the auxiliary memory device 48. When the program installed in the auxiliary memory device is read to the memory and executed by the CPU, the process to be carried out by the maintenance server according to the embodiment is realized. For example, a program for a web server function is installed in the auxiliary memory device 48.

The maintenance information to be provided by the maintenance server 20 may be associated with a suitable code among the failure code, the consumables code, and the code indicative of shift to the maintenance mode, and information which describes this association may be stored in the auxiliary memory device 48. Therefore, upon receipt of a request from the MFP 10, the maintenance server 20 may searche for the maintenance information corresponding to the code contained in the request, and on the basis of the maintenance information create information to be provided to the MFP 10.

Likewise, the controller 11 in the MFP 10 can be realized on the basis of a computer similar to the one shown in FIG. 6. Here, it should be noted that the MFP 10 is not always required to have an auxiliary memory device 48 or a disk drive 50. The MFP 10 may have ROM (Read Only Memory) in which a control program is stored; the control program may be stored in either the ROM or the auxiliary memory device 48. A correction program relative to the control program and a program for an additional function may be installed in the auxiliary memory device 48. The installation may be achieved through downloading via the communication interface 47.

Then, by execution by the CPU 30, the control program stored in the auxiliary memory device 48 or the ROM and also a correction program or an additional function program, if any, stored in the auxiliary memory device 48, control of the MFP 10 including the processes according to the above-described exemplary embodiment is realized. That is, a program which describes the functions of the controller 11, the maintenance event detection section 11a, and the maintenance information acquisition display section 11c is installed in the ROM or the auxiliary memory device 48, and, when the program is executed, an area which functions as the address holding section 11b is ensured in the memory 42.

As for the failure codes relevant to maintenance events, information concerning a condition which serves as the basis for determining occurrence of a relevant failure may be stored in the ROM or the auxiliary memory device 48, and loaded to the memory 42 and utilized by the CPU 40. The determination condition concerning the failure code may be expressed, for example, as a condition concerning a signal output from respective sensors provided to the MFP 10, a condition concerning error information provided by a control program, and so forth.

Likewise, as for the consumable codes relevant to maintenance events, association between consumables and a sensor for determining the consumed or remaining amount of the consumables may be stored in the ROM or the auxiliary memory device 48, and loaded to the memory 42 and utilized by the CPU 40.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A maintenance system, comprising:
a maintenance server that provides maintenance information; and
an image processing device that has at least one of copy, print, facsimile and scan functions and which, upon detection of a maintenance event upon which a maintenance process to be carried out with respect to the image processing device, accesses the maintenance server, acquires from the maintenance server maintenance information indicating a maintenance process corresponding to the detected maintenance event, and displays the acquired maintenance information on a display.

2. The maintenance system according to claim 1, wherein, upon detection as the maintenance event occurrence of a failure to the image processing device, the image processing device acquires from the maintenance server maintenance information indicating a process to be carried out to cope with the failure and displays the acquired maintenance information.

3. The maintenance system according to claim 1, wherein, upon detection as the maintenance event of consumption of consumables used by the image processing device, the image processing device acquires maintenance information indicating a process to be carried out to prepare or exchange the consumables from the maintenance server and displays the acquired maintenance information.

4. The maintenance system according to claim 1, wherein, upon detection as the maintenance event of shift to a maintenance mode, the image processing device acquires maintenance information indicating a maintenance process to be carried out in the maintenance mode from the maintenance server and displays the acquired maintenance information.

5. The maintenance system according to claim 1, wherein the image processing device has a web browser function, the maintenance server has a web server function, and upon detection of the maintenance event, the image processing device obtains or creates a URL which contains an address of the maintenance server and a string corresponding to the detected maintenance event, accesses the maintenance server on the basis of the URL, acquires a web page corresponding to the URL from the maintenance server, and displays the acquired web page.

6. The maintenance system according to claim 1, wherein the maintenance server is connected to a plurality of image processing devices, and the maintenance server collects information concerning a failure or consumption of consumables from the plurality of image processing devices, gathers statistics concerning the failure or service lives of the consumables on the basis of the collected information, and causes each of the image processing devices to display information on the basis of a result of the statistics.

7. The maintenance system according to claim 1, wherein, when acquiring the maintenance information from the maintenance server, the image processing device downloads and executes, upon necessity, at least one of a test program, a test pattern, and firmware from the maintenance server.

8. The maintenance system according to claim 1, wherein, when accessing the maintenance server, the image processing device sends a parameter concerning the image processing device to the maintenance server, and the maintenance server sends maintenance information corresponding to the received parameter to the image processing device.

9. The maintenance system according to claim 8, wherein the parameter concerning the image processing device includes at least one of a model name, a region code, a serial number, a firmware version, a meter value for monochrome printing, a meter value for color printing, a set value of an operation parameter, and output values of a variety of sensors.

10. An image processing device that has at least one of copy, print, facsimile and scan functions, comprising:
a maintenance event detector that detects a maintenance event upon which a maintenance process ought to be carried out with respect to the image processing device;
an address holder that holds an address on a network, of a maintenance server to be accessed when the maintenance event is detected; and
a maintenance information acquirer that accesses, upon detection of the maintenance event by the maintenance event detector, a maintenance server specified by the address held in the address holder, acquires maintenance information indicating a maintenance process corresponding to the maintenance event detected from the maintenance server, and displays the maintenance information on a display.

11. The image processing device according to claim 10, wherein upon detection as the maintenance event of a failure occurring the image processing device, maintenance information indicating a process to be carried out to cope with the failure is acquired from the maintenance server and displayed.

12. A method for displaying maintenance information in an image processing device that has at least one of copy, print, facsimile and scan functions, comprising:
detecting a maintenance event upon which a maintenance process to be carried out with respect to the image processing device;
upon detection of the maintenance event, accessing the maintenance server;
acquiring from the maintenance server maintenance information indicating a maintenance process corresponding to the detected maintenance event; and
displaying the acquired maintenance information on a display.

13. The method according to claim 12, further comprising, upon detection as the maintenance event of a failure occurring in the image processing device, acquiring maintenance information indicating a process to be carried out to cope with the failure from the maintenance server and displaying the acquired maintenance information on the display.

14. A computer readable medium storing a program causing a computer to execute a process for displaying maintenance information in an image processing device that has at least one of copy, print, facsimile and scan functions, the process comprising:
detecting a maintenance event upon which a maintenance process to be carried out with respect to the image processing device;
upon detection of the maintenance event, accessing the maintenance server;
acquiring from the maintenance server maintenance information indicating a maintenance process corresponding to the detected maintenance event; and
displaying the maintenance information acquired on a display.

15. The medium according to claim 14, the process further comprising, upon detection as the maintenance event of a failure occurring in the image processing device, acquiring maintenance information indicating a process to be carried out to cope with the failure from the maintenance server and displaying the acquired maintenance information.

16. A computer data signal embodied in a carrier wave for enabling a computer to perform a process for displaying maintenance information on an image processing device that has at least one of copy, print, facsimile and scan functions, comprising:
detecting a maintenance event upon which a maintenance process to be carried out with respect to the image processing device;
upon detection of the maintenance event, accessing the maintenance server;
acquiring from the maintenance server maintenance information indicating a maintenance process corresponding to the detected maintenance event; and
displaying the acquired maintenance information on a display.

17. The signal according to claim 16, the process further comprising
upon detection as the maintenance event of a failure occurring in the image processing device, acquiring maintenance information indicating a process to be carried out to cope with the failure from the maintenance server and displaying the acquired maintenance information.
